(19) United States
(12) Patent Application Publication
(10) Pub. No.: US 2006/0055807 A1
(43) Pub. Date: Mar. 16, 2006

(54) Imaging methods, image sensors, imaging systems, and articles of manufacture

(76) Inventor: Frederick A. Pemer, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/941,169

(22) Filed: Sep. 14, 2004

(51) Int. Cl. H04N 5/222

(52) U.S. Cl. 348/333.11

(57) ABSTRACT

Imaging methods, image sensors, imaging systems, and articles of manufacture are described. According to one embodiment, an imaging method provides providing an image sensor, receiving light using the image sensor, using the image sensor, providing image data of an image according to a first coordinate space responsive to the receiving, transforming at least a portion of the image data from the first coordinate space to a second coordinate space different than the first coordinate space, and displaying at least a portion of the image using the image data according of the second coordinate space.

### FIELD OF THE DISCLOSURE

Aspects of the disclosure relate to imaging methods, image sensors, imaging systems, and articles of manufacture.

### BACKGROUND OF THE DISCLOSURE

Imaging sensors, devices and systems have experienced numerous advancements in recent years. Further, improvements in electronics have also led to improved digital imaging arrangements. For example, improvements of processors with respect to processing capabilities and speed as well as increased storage capacities of memory circuitry have led to corresponding advancements in imaging systems. Further, networking advancements have also led to improved capabilities with respect to communications of digital image data between processing devices.

Some applications provide for communication of digital image data (e.g., video) over networks. For example, in one conferencing example, one participant may monitor a conference from a remote location using communicated audio and video information. A camera may be rotated or otherwise moved from speaker to speaker of the conference to enable the remote participant to watch the conference participants as well as hear discussions. Further, the camera may be trained upon a blackboard, overhead, or other display device to provide further interaction for the remote participant.

Some conventional techniques may utilize a relatively narrow-field video camera with direction control to select an image from the space surrounding the camera (e.g., participants, blackboard, etc.) for the video information. These implementations may have drawbacks including utilization of relatively complex systems involving a movable video camera as well as a mechanical control apparatus to provide a desired image for communication. Also, with a mechanical approach, there is response time delay for an operator or other automated direction finder to reposition a camera before a new image may be captured.

At least some aspects of the disclosure include apparatus and methods for providing improved imaging.

### SUMMARY

Aspects of the disclosure relate to imaging methods, image sensors, imaging systems, and articles of manufacture.

According to one embodiment, an imaging method comprises providing an image sensor, receiving light using the image sensor, using the image sensor, providing image data of an image according to a first coordinate space responsive to the receiving, transforming at least a portion of the image data from the first coordinate space to a second coordinate space different than the first coordinate space, and displaying at least a portion of the image using the image data according of the second coordinate space.

According to an additional embodiment, an imaging system comprises an image acquisition device configured to generate image data regarding a field of view, wherein the image acquisition device comprises a lens, an image sensor comprising a circular array of photosensitive elements, and storage circuitry configured to store image data corresponding to the substantially hemispherical field of view, and at least one image display device coupled with the image acquisition device and configured to access a subset of the image data from the storage circuitry and to generate an image using the subset of the image data.

Other embodiments and aspects are described as is apparent from the following discussion.

### DESCRIPTION OF THE DRAWINGS

FIG. 1 is a functional block diagram of an exemplary imaging system according to one embodiment.

FIG. 2 is a functional block diagram of an exemplary image acquisition device according to one embodiment.

FIG. 3 is a functional block diagram of an exemplary image display device according to one embodiment.

FIG. 4 is an illustrative representation of an exemplary imaging system according to one embodiment.

FIG. 5 is an illustrative representation of exemplary details of exemplary image data processing according to one embodiment.

FIG. 6 is an illustrative representation of a portion of an image sensor according to one embodiment.

FIG. 7 is a functional block diagram of additional exemplary image data processing according to one embodiment.

FIG. 8 is a flow chart of exemplary operations of an imaging system for depicting images according to one embodiment.

### DETAILED DESCRIPTION

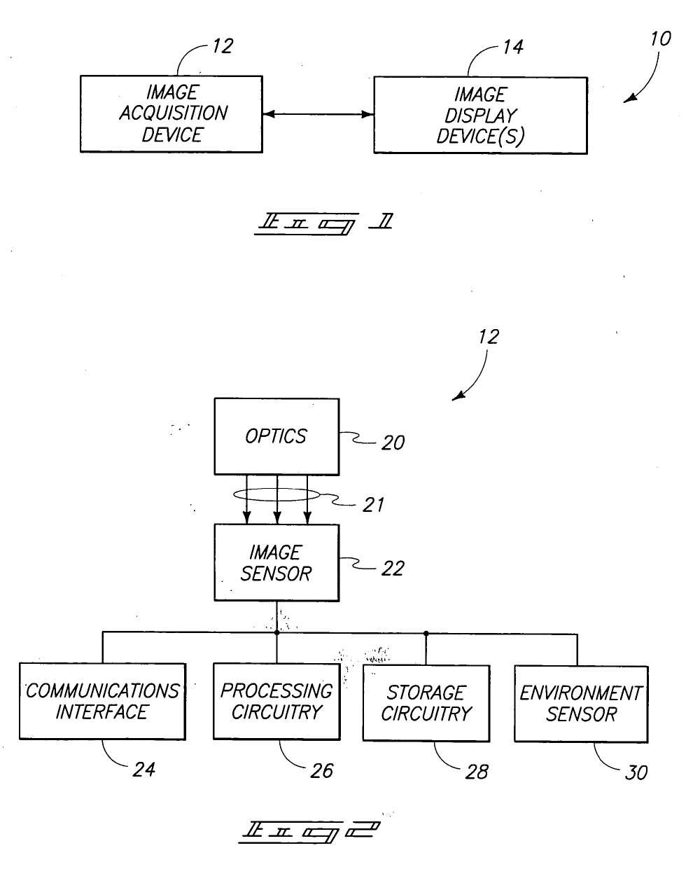

Referring to FIG. 1, an exemplary imaging system 10 is illustrated including an image acquisition device 12 and one or more image display devices 14. Image acquisition device 12 is configured to generate image data of images and to make the image data available for display. One or more image display device 14 may be in communication with a single image acquisition device 12. Image display devices 14 are configured to display images for viewing by users using the same or different image data provided by image acquisition device 12. In some embodiments, image display devices 14 may be individually remotely located with respect to image acquisition device 12 and/or other devices 14 (if present).

Referring to FIG. 2, an exemplary image acquisition device 12 includes optics 20, an image sensor 22, a communications interface 24, processing circuitry 26, storage circuitry 28 and an environment sensor 30. Other configurations are possible and may include more, less and/or alternate components or circuits.

Optics 20 are configured to focus and direct received light 21 of an image to image sensor 22. Optics 20 may comprise one or more lens, aperture adjustment, zoom adjustment, or other appropriate arrangement to focus light 21 to enable accurate generation of image data by image sensor 22. In one embodiment, image acquisition device 12 is embodied as a spherical camera and optics 20 comprise a fish-eye lens arranged to provide a hemispherical field of view in such an embodiment. Optics 20 provide a planar circular image with spherical distortion in the above-described exemplary embodiment.

Image sensor 22 is configured to generate image data (e.g., digital data) responsive to the received light 21. Image sensor 22 may comprise a solid state photo sensor including a plurality of photosensitive elements (e.g., CMOS active pixel sensors (APS), charge couple devices (CCD) sensors, etc.) corresponding to a plurality of pixels in one arrangement. As described further below, image sensor 22 may be arranged as a circular image sensor comprising a circular array of photosensitive elements. Other configurations of image sensor 22 are possible.

Communications interface 24 is configured to implement external communications of image acquisition device 12. For example, communications interface 24 may couple with image display device(s) 14 via an appropriate network connection (e.g., the Internet) and operate to output generated image data, receive commands and enable other communications of device 12 with respect to external devices.

In one embodiment, processing circuitry 26 is arranged to process data, control data access and storage, issue commands, and control other desired operations. Processing circuitry 26 may comprise circuitry configured to implement desired programming provided by appropriate media in at least one embodiment. For example, the processing circuitry 26 may be implemented as one or more of a processor and/or other structure configured to execute executable instructions including, for example, software and/or firmware instructions, and/or hardware circuitry. Exemplary embodiments of processing circuitry 26 include hardware logic, PGA, FPGA, ASIC, state machines, and/or other structures alone or in combination with a processor. These examples of processing circuitry 26 are for illustration and other configurations are possible. Processing circuitry 26 may be configured to implement operations with respect to acquisition of images, providing image data, controlling storage of image data, processing of commands and controlling other operations of image acquisition device 12.

Storage circuitry 28 is configured to store electronic data and/or programming such as executable instructions (e.g., software and/or firmware), data, or other digital information and may include processor-usable media. Processor-usable media includes any article of manufacture which can contain, store, or maintain programming, data and/or digital information for use by or in connection with an instruction execution system including processing circuitry in the exemplary embodiment. For example, exemplary processor-usable media may include any one of physical media such as electronic, magnetic, optical, electromagnetic, infrared or semiconductor media. Some more specific examples of processor-usable media include, but are not limited to, a portable magnetic computer diskette, such as a floppy diskette, zip disk, hard drive, random access memory, read only memory, flash memory, cache memory, and/or other configurations capable of storing programming, data, or other digital information. Storage circuitry 28 may be embodied as multi-port frame buffer memory in one embodiment. In such an exemplary arrangement, storage circuitry 28 embodied as multi-port frame buffer memory may operate to output parallel data streams of image data to a plurality of image display devices 14. Other implementations are possible.

Environment sensor 30 is arranged to monitor an environment about the image acquisition device 12. For example, environment sensor 30 may monitor motion or movement, voice, or other environmental characteristics for example in the field of view of optics 20 and provide control signals responsive to the monitoring. The control signals provided by environment sensor 30 may be used to control image acquisition operations of device 12 in one embodiment.

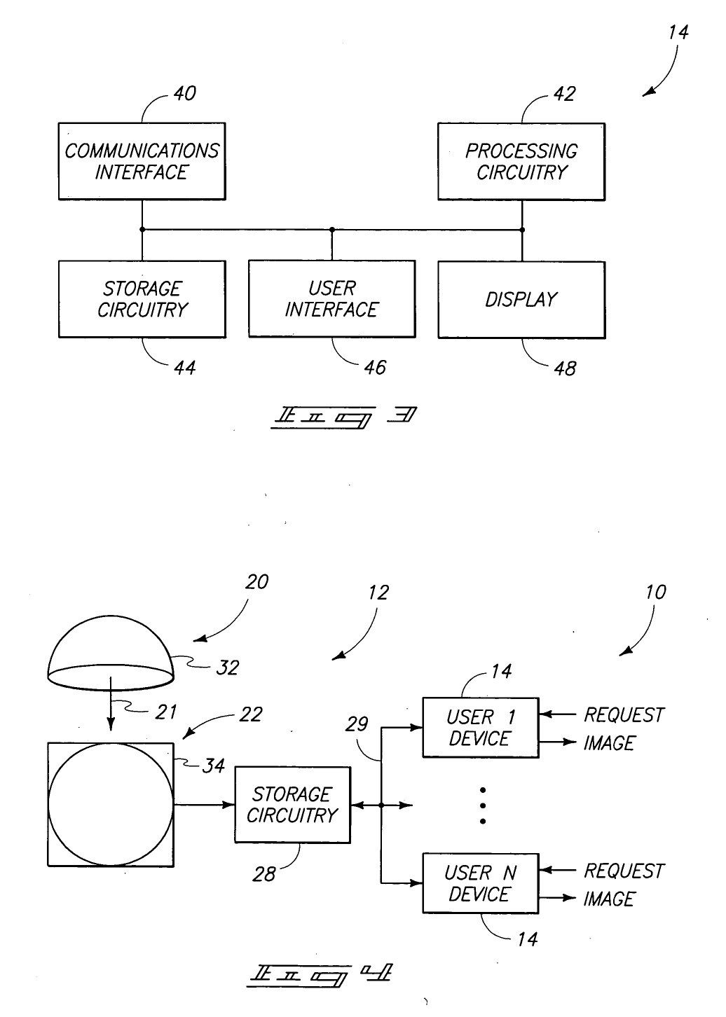

Referring to FIG. 3, an exemplary image display device 14 includes a communications interface 40, processing circuitry 42, storage circuitry 44, a user interface 46, and a display 48. Other configurations are possible including more, less and/or alternate components or circuits.

Communications interface 40 is configured to implement external communications of image display device 14. For example, communications interface 40 may couple with image acquisition device 12 via an appropriate network connection (e.g., the Internet) and operate to receive generated image data, output commands and enable communications of device 14 with respect to external devices.

Processing circuitry 42 is configured to formulate commands for communication to data acquisition device 12, to access image data from image acquisition device 12, and to process the image data prior to depiction of corresponding images using display 48. Exemplary processing of image data is discussed further below. In one embodiment, processing circuitry 42 may be implemented similar to processing circuitry 26 discussed above.

Storage circuitry 44 may comprise a buffer configured to store received image data and to provide the image data for processing by processing circuitry 42 and display. Storage circuitry 44 may also store additional digital data and/or executable instructions and may be implemented similar to storage circuitry 28 discussed above.

Display 48 is configured to depict images corresponding to received image data in one embodiment. Display 48 may comprise a cathode ray tube (CRT) display, LED display, or any other appropriate configuration to depict images.

Referring to FIG. 4, an exemplary implementation of imaging system 10, such as for use in a remote video conferencing monitoring application, is shown. In the depicted example, image acquisition device 12 is installed at a location wherein images are captured for communication to image display devices 14 associated with respective users 1-N. Optics 20 of device 12 may be configured to capture images from a wide angle in one implementation. For example, optics 20 may provide images from a substantially hemispherical field of view and include a fish-eye lens 32 in one implementation. If fish-eye lens 32 is affixed to the ceiling of a room (not shown), images may be generated for any subject of interest within the room. Other configurations are possible in other embodiments.

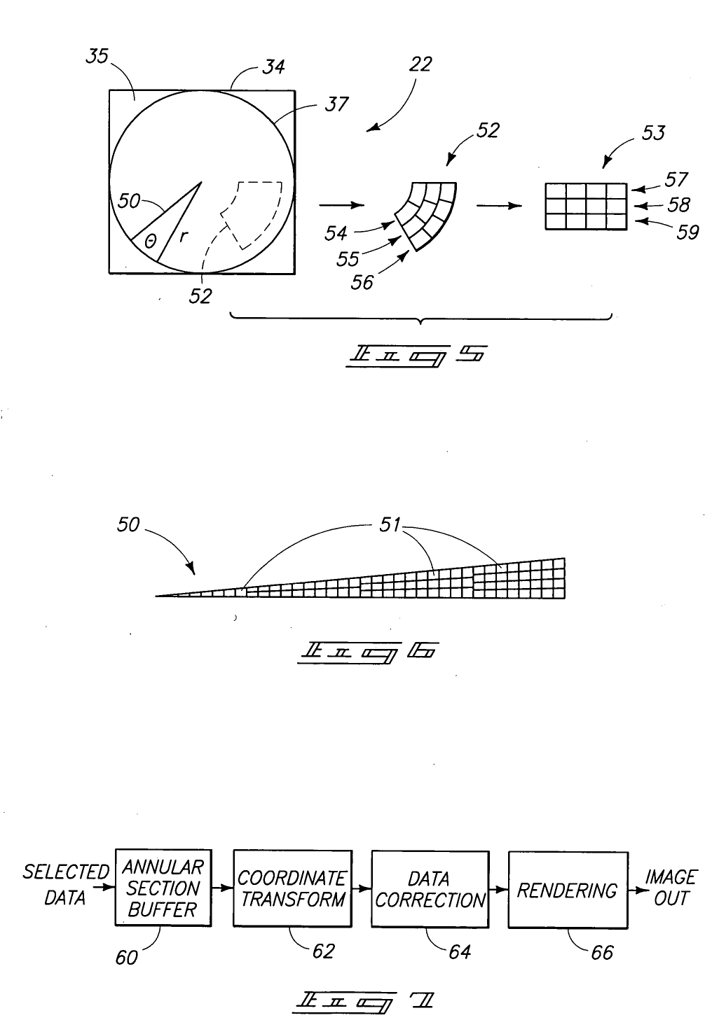

Image sensor 22 is configured as a circular array 34 of photosensitive elements in the depicted exemplary embodiment. Additional details of the circular array 34 of FIG. 4 are described below in illustrative examples with respect to FIGS. 5-6. Circular array 34 is aligned with lens 32 to receive outputted light therefrom. The photosensitive elements (see FIG. 6) are configured to output electrical signals corresponding to the received light. In one embodiment, the electrical signals may comprise digital data representing intensity of light received via the respective photosensitive elements.

In the exemplary embodiment described above, storage circuitry 28 may be embodied as multi-port frame buffer memory configured to receive raw image data in the form of the electrical signals from image sensor 22. Storage circuitry 28 may output acquired image data to one or more user image display device 14 in parallel using an appropriate communications medium 29 (e.g., the Internet and/or other desired network and/or communications arrangement).

In one arrangement, individual image display devices 14 may depict the same images using image data from image acquisition device 12. In another embodiment, different devices 14 may depict different images. For example, a user of one image display device 14 may submit a request which is communicated as a request or command to image acquisition device 12 for a first subset of captured image data. Image acquisition device 12 may process the request or command and communicate the requested subset of image data to the respective device 14 which operates to depict the requested image. At the same time, a different user may request a different subset of data from device 12 for respective display of a different image.

Referring to FIGS. 5-6, exemplary details regarding processing to provide subsets of captured image data and correction of imaging defects (e.g., distortion introduced by fish-eye lens 32) are described.

As mentioned above, image sensor 22 may be embodied as a circular array 34 of photosensitive elements 51. The photosensitive elements 51 may be supported by or otherwise coupled with or embedded within a substrate 35 (e.g., semiconductive material such as silicon) in one arrangement. An exemplary slice 50 of photosensitive elements 51 for an angle theta (θ) and radius r is shown in FIGS. 5-6. Photosensitive elements 51 correspond to pixels in one embodiment and individually comprise a substantially common surface area in the described example to provide equal photo collection areas. Photosensitive elements 51 may be arranged as a set of annular rings of pixels that increase in the number of pixels in the rings in a progression direction from a center of the circular array 34 to an outer edge or circumference 37. Accordingly, the photosensitive elements 51 may be arranged in a plurality of groups within circumference 37 of the circular array 34 wherein individual groups comprise a ring of a plurality of photosensitive elements 51 provided at a common radius of circular array 34.

One exemplary image sensor 22 including a circular array 34 may comprise an amorphous silicon photo sensor array fabricated on top of a silicon substrate 35 wherein individual photosensitive elements 51 are represented as a substantially square pixel of 5 microns by 5 microns (25 micron²) sensor. A circular photo sensor array of approximately 10 mm in diameter may be used to implement circular array 34. The above-described sensor 22 may have a radius of 1000 pixels (diameter/2/pixel length=10 mm/2/5 microns=1000 pixels). The circumference 37 of the above-described sensor 22 is 6280 pixels (diameter*Pi/pixel length=10 mm*3.14/5 microns=6280 pixels). Other configurations of image sensor 22 are possible.

In some embodiments (e.g., optics 20 comprising a fish-eye lens 32), it may be desirable to provide images using only a portion of image data generated corresponding to the field of view. The data acquisition device 12 implemented as a spherical camera enables selection of any annular section of image data captured by photosensitive elements 51 to provide resultant depicted images. If an entire image is captured at one exposure, a user or other stimulus (e.g., output of environment sensor 30) may select any annular section to view and/or move around the image by selecting a number of annular sections (overlapping or separate) to view any direction in the field of the fish-eye lens 32 of optics 20. In another arrangement, a given annular section may be dynamically selected during an exposure period so that only image data from the selected annular section is generated by the image sensor 22.

Accordingly, in one embodiment, image data from a subset 52 of photosensitive elements 51 may be used to create an image for one or more image display device 14. In some embodiments, image data from different subsets 52 may be used to create different images for display by different devices 14. In the described embodiment, subset 52 comprises a section of an annular ring defined by one or more groups of photosensitive elements 51 and a given angle, and subset 52 may be referred to as an annular subset in such an embodiment.

According to examples wherein photosensitive elements 51 are arranged in image sensor 22 as a circular array 34, it may be desirable to utilize different coordinate spaces to identify and select desired subsets 52 of photosensitive elements 51. Display acquisition device 12 may use a spherical coordinate space (desired angle and radius) to access desired image data. It may also be desired to depict the accessed image data in a more conventional arrangement (e.g., rectangular) for familiar display to a user and accordingly a second coordinate space may be used to implement display operations of the image data. In exemplary implementations, system 10 may transform image data organized according to a first coordinate space (e.g., spherical) to a second coordinate space (e.g., rectangular). An annular subset 52 of image data may be mapped into a rectangular section or image in one embodiment. The mapping may remove spherical distortion introduced by fish-eye lens 32 or other arrangement of optics 20 to provide the appearance of a rectangular frame in the resultant image from annular data. Devices 12, 14 may operate alone or in combination with one another to implement the desired transformation or mapping.

Upon selection by an appropriate device (e.g., device 12 or device 14), a desired subset 52 of photosensitive elements 51 (and image data therefrom) may be identified. As described above, the subset 52 may comprise an annular section comprising a plurality of groups of photosensitive elements 51 which fall within a desired angle (theta). Using appropriate mapping and transformation operations (e.g., spherical-to-rectangular transformation algorithms) and with reference to FIG. 5, subset 52 comprising image data from an annular section of photosensitive elements 51 may be arranged as a rectangular subset 53 for subsequent depiction using display 48 (subsets 52, 53 illustrating exemplary annular and rectangular geometries are merely for discussion and typical subsets 52, 53 may comprise thousands of pixels in some aspects).

In one arrangement, individual groups of photosensitive elements 51 (each having a common radius as discussed above) of an annular subset 52 may be mapped to respective rows of rectangular subset 53. In the example of FIG. 5, image data of groups 54-56 of photosensitive elements 51 of annular subset 52 may be rearranged into respective rows 57-59 of rectangular subset 53. In the described example, leftmost pixel image data of groups 54-56 may be mapped into leftmost pixel image data of respective rows 57-59 and similar mapping may be used for central and rightmost data. Accordingly, in one embodiment, the image data captured by image sensor 22 includes image data obtained at a plurality of different radii (i.e., different groups of image data), and the image data of the different radii or groups corresponds to image data of respective rows of a resultant rectangular image. Further, image data of at least some of the columns of the resultant rectangular image of the described embodiment may include image data lying in a common radial direction of the spherical coordinate space of the image sensor 22 in one embodiment.

One of the groups 54-56 having the largest number of photosensitive elements 51 (i.e., the largest radius) may be used to define the width of rectangular subset 53. For example, group 56 may define the width in the embodiment of FIG. 5. For groups of photosensitive elements having less photosensitive elements 51 than the width (e.g., groups 54, 55), additional image data may be generated to populate the respective rows 57, 58 in the rectangular subset 53. In one example, data correction operations (e.g., interpolation) may be implemented using device 12 and/or device 14 to populate the data in the respective rows 57, 58 using adjacent image data. Other data population techniques may be used in the other embodiments to provide additional image data.

With reference again to the above-described sensor 22 having 6280 pixels, a reasonable rectangular (VGA) image has a rectangular area corresponding to rectangular subset 53 having a size of 640 pixels by 480 pixels. One possible annular subset 52 of the circular array 34 may have an inner radius of 520 pixels and outer radius of 1000 pixels. The annular subset 52 may further have an outer base (i.e., circumference corresponding to the respective radius) of 640 pixels and an inner base of 333 pixels. The above-described annular subset 52 may reasonably map to the described VGA rectangular frame in an arrangement to reduce distortion. Additional image data may be generated for example using interpolation to fill the rectangular frame. In the described example, approximately ten complete VGA frames may be obtained from an outer perimeter of exemplary image sensor 22 comprising photosensitive elements 51 arranged in a circular array 34 having a diameter of 10 mm.

Image display device 12 may implement transformation operations by storing image data of subset 52 in storage circuitry 28 arranged as rectangular image buffer memory wherein image data of respective groups of photosensitive elements 51 are stored within respective rows of the memory. Device 12 may address the memory using spherical coordinates in one embodiment (e.g., individual rows may be identified by a radius value and respective locations in the rows may be identified by angular values).

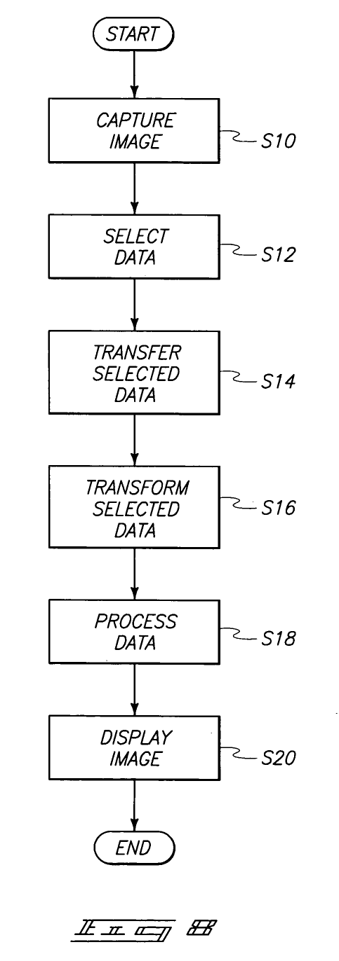

Referring to FIG. 7, exemplary operations implemented by image display device 14 are shown. A user may identify a desired image to be depicted from the field of view, and the image display device 14 may communicate parameters (e.g., frame size, center of image, theta and radius) identifying the desired image to image acquisition device 12. In other embodiments, the output of sensor 30 selects the desired data. Data retrieved from image acquisition device 12 may be stored internally of image display device 14 using annular section buffer 60 of storage circuitry 44.

Processing circuitry 42 may perform a coordinate transform operation 62 to map the data from spherical coordinates into rectangular coordinates (or other desired configuration) for display. In one example, groups (i.e., rows stored within frame buffer memory of device 12) of data received from image acquisition device 12 correspond to rows of a rectangular frame as mentioned above. Processing circuitry 42 may implement a data correction operation 64 (e.g., using interpolation) to populate rows having less image data compared with others of the rows and reduce distortion (e.g., distortion introduced by a fish-eye lens 32 if used). Processing circuitry 42 may also perform a data rendering operation 66 before the image is displayed. An exemplary data rendering operation 66 includes digital processing such as contrast, sharpness, color processing, and/or other processing.

Referring to FIG. 8, an exemplary methodology is shown and which is executed by image acquisition device 12 to acquire image data and image display device 14 to depict an image using the image data. Other methods are possible including more, less or alternative steps. Further, the execution of one or more step may be performed by circuits or devices other than those described according to the example of FIG. 8.

At a step S10, image acquisition device 12 operates to capture and internally store raw image data from a respective image sensor within frame buffer memory. In an exemplary embodiment using a fish-eye lens described above, the image data may comprise data of substantially a hemispherical field of view. The captured image data may be defined by an array nΔθ, mΔr where n may be defined as the number of pixels along the outer base (outside circumference of an annular subset 52 divided by the pixel base) and m may be defined as the number of pixels along the radius of the annular subset 52 (delta radius between the inner and outer bases divided by the pixel height).

At a step S12, one or more user may select desired image(s) to be depicted and the request(s) may be communicated from respective image display device(s) 14 to image acquisition device 12. In other embodiments, an environment sensor may be used to monitor an environment of the image acquisition device 12 and to select the image data to be depicted responsive to the monitoring. Other selection operations are possible.

At a step S14, the selected image data may be extracted from frame buffer memory and communicated to the respective device(s) 14 at step S14. Further, the same or different image data may be communicated to other devices 14. The communicated image data may include raw image data including a subset Nu1×Mu1 from the n×m frame buffer.

At a step S16, the individual image display device(s) 14 may transform or map the selected data from a first coordinate space (R, theta) to a second coordinate space (x, y). Optical distortion introduced by the optics may be removed and interpolation may be used to add additional rectangular data in the described example.

At a step S18, the individual image display device(s) 14 may process the respective image data including color, contrast, sharpness and/or other processing.

At a step S20, the image display device(s) 14 may depict the respective images.

The above exemplary methodology may be repeated to provide a plurality of video frames comprising a plurality of images generated from acquired image data in one implementation.

Exemplary aspects of the disclosure provide improved imaging methods, systems and apparatus. For example, some of the above-described aspects enable image acquisition device 12 to capture images from all angles in a field of view of the device 12 without moving parts. Some further aspects of the disclosure provide an effective video conferencing arrangement without the need for a mechanically directed “narrow field” camera. Image acquisition device 12 embodied as the above-described spherical camera may be placed at a center of a conference room or conference table and either capture and transmit video frames containing data from all or subsets of the pixels of the circular array 34 for processing by an image display device 14. In one video conferencing arrangement, the output of image data from the image acquisition device 12 is automatically directed by sound to the person speaking. Environment sensor 30 may include at least a directional voice sensor in such an embodiment.

In another exemplary implementation, the above-described spherical camera may replace a mechanically directed wide-angle camera in a surveillance application where a user desires to focus onto or track objects anywhere in proximity to device 12. A full frame of spherical camera data contains all the details surrounding the camera so that an annular section corresponding to a direction or object may be selected and mapped into at least a substantially distortion-free video frame.

Yet additional aspects of the disclosure provide an annular photo capture array which is more straightforward computational-wise to process than an annular section of data obtained by a rectangular array of photo sensors. Further, output of image sensor 22 comprising a circular array 34 of photosensitive elements 51 may contain all image information, at all angles and elevations. Selected resultant images may be processed using subsets of image data after the image is captured by optics 20.

The exemplary imaging systems 10 may solve problems of pre-selecting a direction of a narrow-field camera to focus onto a selected object or view in a selected direction inasmuch as aspects of the disclosure enable all data within sight of image acquisition device 12 to be captured in each frame in some embodiments. To view in a selected direction, an appropriate annular section of data may be selected from data captured in the circular array 34 and mapped from an annular/spherical section or space to a rectangular frame. According to these exemplary described aspects, any frame contained in an entire scene may be electronically viewed without using a camera with mechanical moving parts.

Utilization of image sensor 22 including a circular array 34 of photosensitive elements 51 according to some of the described aspects provides increased efficiency (approximately 25%) compared with usage of a square image sensor wherein information from corner pixels is disregarded. Further, usage of a square image sensor results in mapping of increased complexity for an image from any angle or elevation compared with usage of the above-described exemplary image sensor 22 having a circular array 34 of photosensitive elements 51 providing mapping of an annular section to a rectangular array in exemplary embodiments.

The protection sought is not to be limited to the disclosed embodiments, which are given by way of example only, but instead is to be limited only by the scope of the appended claims.

What is claimed is:

1. An imaging method comprising:
providing an image sensor;
receiving light using the image sensor;
using the image sensor, providing image data of an image according to a first coordinate space responsive to the receiving;
transforming at least a portion of the image data from the first coordinate space to a second coordinate space different than the first coordinate space; and
displaying at least a portion of the image using the image data according of the second coordinate space.

2. The method of claim 1 wherein the transforming comprises transforming an annular section of the image data into a rectangular arrangement of the image data.

3. The method of claim 1 wherein the first coordinate space comprises a spherical coordinate space and the second coordinate space comprises a rectangular coordinate space.

4. The method of claim 3 wherein the transforming provides the image data in a plurality of rows and columns.

5. The method of claim 4 wherein the image data of the spherical coordinate space comprises image data obtained at a plurality of different radii, and the image data of the different radii corresponds to image data of respective ones of the rows.

6. The method of claim 4 wherein at least some of the image data of the columns comprises image data lying in a common radial direction of the spherical coordinate space.

7. The method of claim 1 wherein the transforming provides at least one of the rows having less amount of image data than another of the rows, and further comprising providing additional image data for the at least one row.

8. The method of claim 7 wherein the providing the additional image data comprises providing using interpolation.

9. The method of claim 1 wherein the receiving comprising focusing the light upon the image sensor using a lens, and wherein the providing comprises providing a circular image sensor comprising a circular array of photosensitive elements.

10. An image sensor comprising:
a substrate; and
a plurality of photosensitive elements coupled with the substrate and wherein individual ones of the photosensitive elements are configured to receive light and to generate respective electrical signals indicative of the received light; and
wherein the photosensitive elements are arranged in a circular array in a plurality of groups inside of a circumference of the circular array, and individual ones of the groups comprise a plurality of the photosensitive elements spaced at a common radius of the circular array.

11. The sensor of claim 10 wherein the groups individually comprise an annular ring of the photosensitive elements having a common radius.

12. The sensor of claim 10 wherein the photosensitive elements have a common area.

13. An imaging system comprising:
an image acquisition device configured to generate image data regarding a field of view, wherein the image acquisition device comprises:
a lens;
an image sensor comprising a circular array of photosensitive elements; and
storage circuitry configured to store image data corresponding to the substantially hemispherical field of view; and
at least one image display device coupled with the image acquisition device and configured to access a subset of the image data from the storage circuitry and to generate an image using the subset of the image data.

14. The system of claim 13 wherein the image acquisition device is configured to generate annular image data and the image display device is configured to generate the image comprising a substantially rectangular image.

15. The system of claim 13 wherein the lens comprises a fish-eye lens having a substantially hemispherical field of view.

16. The system of claim 13 wherein the image display device is configured to provide a command identifying the subset of the image data.

17. The system of claim 13 wherein the image acquisition system comprises a sensor configured to monitor the environment corresponding to the field of view and to identify the subset of the image data responsive to the monitoring.

18. The system of claim 17 wherein the sensor is configured to identify the subset responsive to a human voice.

19. The system of claim 17 wherein the sensor is configured to identify the subset responsive to detected motion.

20. The system of claim 13 wherein the subset corresponds to a desired location of the field of view.

21. The system of claim 13 wherein the at least one image display device comprises a plurality of image display devices.

22. The system of claim 13 wherein the subset comprises an initial subset and the image comprises an initial image, and further comprising another image display device configured to access another subset of the image data and to generate another image using the another subset of the image data.

23. The system of claim 22 wherein the image display devices are configured to generate the initial image and the another image comprising different images and the initial subset and the another subset comprise different subsets of a common set of image data stored using the storage circuitry.

24. The system of claim 22 wherein no physical movement of the lens is implemented to provide the initial and the another subsets of the image data.

25. The system of claim 13 wherein the image acquisition device is configured to generate the image data according to a first coordinate space, the image display device is configured to display the image using the image data arranged according to a second coordinate space different than the first coordinate space.

26. An imaging system comprising:
image means for providing image data according to a first coordinate space;
storage means for storing the image data;
processing means for accessing at least a subset of the image data from the storage means and for transforming an arrangement of the subset of the image data from the first coordinate space to a second coordinate space; and
display means for displaying an image of the subset of the image data according to the second coordinate space.

27. The system of claim 26 wherein the first coordinate space comprises a spherical coordinate space and the second coordinate space comprises a rectangular coordinate space.

28. The system of claim 27 wherein the image means comprises a circular image sensor comprising a circular array of photosensitive elements.

29. The system of claim 26 wherein the processing means comprises means for transforming an annular section of the image data into a rectangular arrangement of the image data.

30. The system of claim 26 wherein the processing means comprises means for interpolating image data of the subset of the image data.

31. An article of manufacture comprising:
a medium configured to store executable code configured to cause processing circuitry to:
access image data obtained using a circular image sensor comprising a plurality of photosensitive elements arranged in a plurality of annular rings having different radii;
provide the image data into a rectangular arrangement having a desired width, and wherein the image data of the annular rings corresponds to respective rows of the rectangular arrangement and wherein individual ones of the rows comprise different amounts of the image data corresponding to the different radii of respective ones of the annular rings;
generate additional image data for individual ones of the rows of the rectangular arrangement comprising less image data than the desired width;
populate individual ones of the rows of the rectangular arrangement comprising less image data than the desired width using the additional image data.

32. The article of claim 31 wherein the executable code is configured to cause processing circuitry to interpolate the accessed image data to generate the additional image data.

33. The article of claim 31 wherein the executable code is configured to cause processing circuitry to issue a command and to access the image data comprising a subset of image data obtained using the circular image sensor, and the accessed data corresponds to the command.
